(19) United States
(12) Patent Application Publication
(10) Pub. No.: US 2019/0300267 A1
(43) Pub. Date: Oct. 3, 2019

(54) INSULATING HOLDER FOR BEVERAGE CONTAINER

(71) Applicant: Richard Green, Santa Monica, CA (US)

(72) Inventor: Richard Green, Santa Monica, CA (US)

(21) Appl. No.: 15/940,900

(22) Filed: Mar. 29, 2018

(51) Int. Cl. B65D 81/38

(52) U.S. Cl. CPC B65D 81/3879; C08L 2207/066

(57) ABSTRACT

An insulating holder for a beverage container includes a sleeve including foam and also including a front surface and a back surface. The foam is configured to reduce a rate of heat transfer between the front surface and the back surface of the sleeve. The sleeve is configured to be placed around an outer surface of the beverage container. The front surface of the sleeve is configured to be held in a hand of a user.

### TECHNICAL FIELD

The present disclosure relates generally to holders for beverage containers. More specifically, the present disclosure relates to a reusable insulating sleeve for beverage containers.

### BACKGROUND

When a beverage container (e.g., a cup) is filled with a hot beverage, there is a risk that a beverage consumer may suffer mild to severe burning if the consumer holds the beverage container in a hand without insulation. This is particularly true if the beverage container is made of a thin, disposable paper material having poor insulation properties.

Previous approaches to avoiding burning of a hand of a beverage consumer may relate to a an entire cup made of a good insulating material. However, such approaches result in increased manufacturing and shipping costs due to an excessive use of insulating material for the entire cup. Additionally, making an entire cup of insulating material is generally unnecessary because consumers hold the cup in the middle.

Other previous approaches may relate to a cup holder into which the beverage container is inserted and by which the consumer can hold the beverage container in a hand. For example, previous approaches relate to cup holders which include a sleeve made out of a corrugated material (e.g., corrugated paper). These cup holders may include one or two pieces and may be configured to be manufactured and shipped as a flat sheet. Accordingly, these cup holders require means to secure one end of the flat sheet to another end of the flat sheet to create a useable cup holder. For example, glue may be also required to maintain the cup holders in place. The securing of ends together may require an additional step to be performed by a vendor prior to selling and delivering a beverage container filled with a hot beverage to a customer.

The previous approaches to cup holders suffer from a number of drawbacks. For example, corrugated materials such as corrugated paper does allow some heat conduction from the hot cup to the consumer's hand because the paper absorbs some heat, so there is still a risk of some burning and/or discomfort to the consumer. As another example, because the corrugated paper is relatively heavy and therefore leads to high freight costs. Additionally, the corrugated paper cup holders may not provide a good comfortable experience for a consumer using the cup holder. Also, the corrugated paper cup holders create environmental costs because they are single use and cannot be washed without destroying the cup holder. Even if the corrugated paper cup holders are recycled, they contribute to greenhouse gas emissions.

There is a need therefore for a light-weight, reusable, and comfortable cup holder which provides insulation to a consumer's hand when the consumer is holding a beverage container filled with a hot liquid. Additionally, there is a need for a cup holder which does not increase greenhouse gas emissions when the cup holder is recycled.

### SUMMARY

According to one exemplary embodiment of the present disclosure, an insulating holder for a beverage container includes a sleeve including foam and also including a front surface and a back surface, the foam being configured to reduce a rate of heat transfer between the front surface and the back surface of the sleeve. The sleeve is configured to be placed around an outer surface of the beverage container. The front surface of the sleeve is configured to be held in a hand of a user.

According to one aspect of the insulating holder, the foam includes polyurethane.

According to another aspect of the insulating holder, the polyurethane is low density polyethylene.

According to another aspect of the insulating holder, the reduction in the rate of heat transfer between the front surface and the back surface of the sleeve is such that a temperature on the front surface of the sleeve is not greater than about 100 degrees Fahrenheit when a beverage held in the beverage container has a temperature of between 205 and 212 degrees Fahrenheit.

According to another aspect of the insulating holder, the reduction in the rate of heat transfer between the front surface and the back surface of the sleeve is such that the temperature on the front surface of the sleeve is about 99 degrees Fahrenheit when a beverage held in the beverage container has a temperature of between 205 and 212 degrees Fahrenheit.

According to another aspect of the insulating holder, the sleeve also includes a first end and a second end.

According to another aspect of the insulating holder, the first end and the second end of the sleeve are melted together thereby providing a seal between the first end and the second end.

According to another aspect of the insulating holder, the sleeve has a conical shape having a circular cross section.

According to another aspect of the insulating holder, the sleeve is also configured to be reusable.

According to another exemplary embodiment of the present disclosure, a beverage container and holder combination includes a beverage container; and an insulating holder including a sleeve including foam and also including a front surface and a back surface. The foam is configured to reduce a rate of heat transfer between the front surface and the back surface of the sleeve. The sleeve is configured to be placed around an outer surface of the beverage container. The front surface of the sleeve is configured to be held in a hand of a user.

According to one aspect of the combination, the foam includes polyurethane.

According to another aspect of the combination, the polyurethane is low density polyethylene.

According to another aspect of the combination, the reduction in the rate of heat transfer between the front surface and the back surface of the sleeve is such that a temperature on the front surface of the sleeve is not greater than about 100 degrees Fahrenheit when a beverage held in the beverage container has a temperature of between 205 and 212 degrees Fahrenheit.

According to another aspect of the combination, the reduction in the rate of heat transfer between the front surface and the back surface of the sleeve is such that the temperature on the front surface of the sleeve is about 99 degrees Fahrenheit when a beverage held in the beverage container has a temperature of between 205 and 212 degrees Fahrenheit.

According to another aspect of the combination, the sleeve also includes a first end and a second end.

According to another aspect of the combination, the first end and the second end of the sleeve are melted together thereby providing a seal between the first end and the second end.

According to another aspect of the combination, the sleeve has a conical shape having a circular cross section.

According to another aspect of the combination, the sleeve is also configured to be reusable.

According to another exemplary embodiment of the present disclosure, a method of insulating a beverage container includes the steps of providing a beverage container; providing an insulating holder for the beverage container, the insulating holder including a sleeve including foam and also including a front surface and a back surface; and inserting the beverage container into the sleeve, The foam is configured to reduce a rate of heat transfer between the front surface and the back surface of the sleeve. The sleeve is configured to be placed around an outer surface of the beverage container. The front surface of the sleeve is configured to be held in a hand of a user.

According to one aspect of the method, the foam includes low density polyurethane.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below, and particularly pointed out in the claims filed with the application. Such combinations have particular advantages not specifically recited in the above summary. Other features and advantages of the present invention will be apparent from the accompanying drawings and from the detailed description that follows below.

### BRIEF DESCRIPTION OF THE DRAWINGS

The disclosure may be best understood by referring to the following description and accompanying drawings that are used to illustrate embodiments of the disclosure by way of example and not limitation, without departing from the spirit and scope of the disclosure. In the drawings, like reference numerals indicate similar elements.

FIG. 1 is a side elevation view of an insulating holder in combination with a beverage container, according to one exemplary embodiment of the present disclosure.

FIG. 2 is a side elevation view of the insulating holder shown in FIG. 1.

FIG. 3 is a top plan view of the insulating holder shown in FIG. 1 in an unassembled form.

FIG. 4 is a side elevation view of the combination of the insulating holder and the beverage container shown in FIG. 1 in an inverted orientation.

### DETAILED DESCRIPTION

In the following description, numerous specific details are set forth. However, it is understood that embodiments of the invention may be practiced without these specific details. In other instances, well-known circuits, structures, and techniques have not been shown in detail in order not to obscure the understanding of this description.

In the following description, reference is made to the accompanying drawings, which illustrate several embodiments of the present invention. It is understood that other embodiments may be utilized, and mechanical compositional, structural, electrical, and operational changes may be made without departing from the spirit and scope of the present disclosure. The following detailed description is not to be taken in a limiting sense, and the scope of the embodiments of the present invention is defined only by the claims of the issued patent.

The terminology used herein is for the purpose of describing particular embodiments only and is not intended to be limiting of the invention. Spatially relative terms, such as “beneath”, “below”, “lower”, “above”, “upper”, and the like may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (e.g., rotated 90 degrees or at other orientations) and the spatially relative descriptors used herein interpreted accordingly.

As used herein, the singular forms “a”, “an”, and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

The terms “or” and “and/or” as used herein are to be interpreted as inclusive or meaning any one or any combination. Therefore, “A, B or C” or “A, B and/or C” mean any of the following: A; B; C; A and B; A and C; B and C; A, B and C.” An exception to this definition will occur only when a combination of elements, functions, steps or acts are in some way inherently mutually exclusive.

Several embodiments of the invention with reference to the appended drawings are now explained. Whenever the shapes, relative positions and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

Referring generally to the FIGURES, an insulating holder for a beverage container includes a sleeve made of a foam material. The sleeve is configured to slide around the outer surface of the beverage container and is also configured to be reusable.

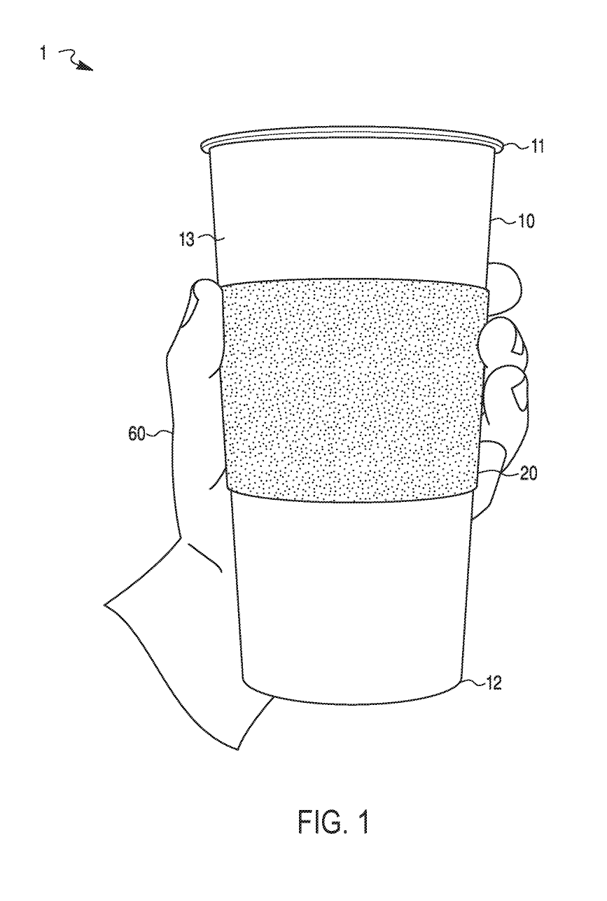

Referring to FIG. 1, a combination 1 of a beverage container (e.g., cup, etc.) 10 and a sleeve 20 is shown. The beverage container 10 may be any commercially available beverage container which is used to provide hot beverages to consumers by beverage providers. For example, the beverage container 10 includes a top, open end 11 which includes a lip and a closed, bottom end 12. The beverage container 10 may have a slight taper to it, that is, a size of a diameter of the closed, bottom end 12 may be slightly less than a size of a diameter of the top, open end 11 of the beverage container 10. The beverage container 10 also includes an outer surface 13 and an inner surface (not shown) in which the beverage is contained within the beverage container 10.

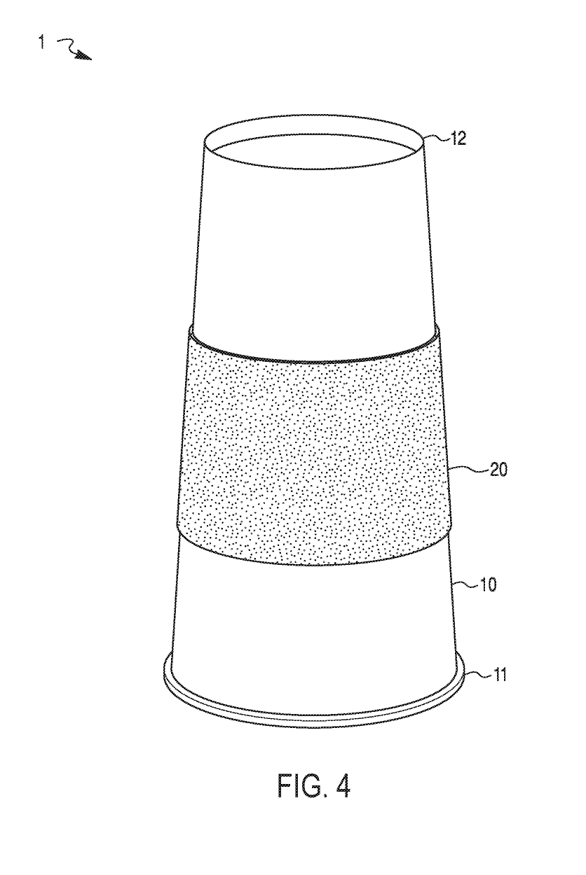

As shown in FIGS. 1 and 4, the combination 1 also includes a sleeve 20. The sleeve 20 is configured to be inserted around the outer surface 13 of the beverage container 10. The sleeve 20 is also configured to be held by a hand 60 of a user. Accordingly, the sleeve 20 is sized appropriate so that it will fit securely around the outer surface 13 of the beverage container 10 in a middle portion of the beverage container 10. According to one aspect, the sleeve 20 is configured to slide along the outer surface 13 of the beverage container 10 from the closed, bottom end 12 of the beverage container 10 towards the top, open end 11 of the beverage container 10 until the sleeve 20 fits snugly in place in the middle portion of the outer surface 13.

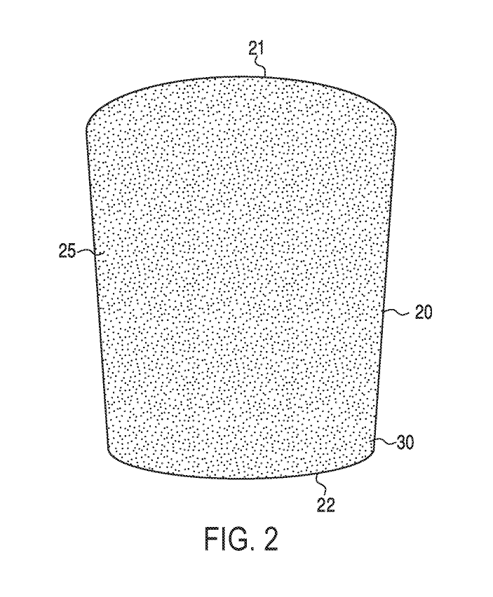

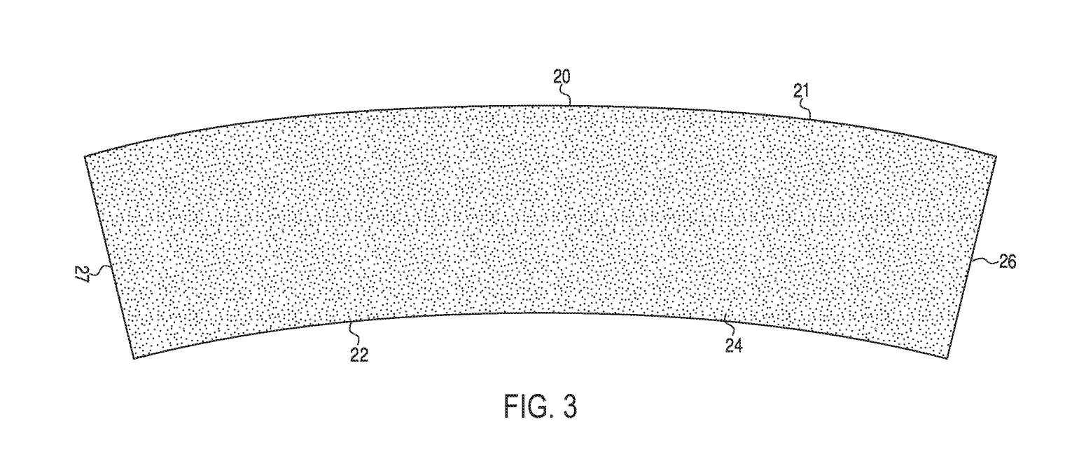

As shown in FIG. 2-3, the sleeve 20 includes a top side 21 and a bottom side 22. The sleeve 20 also includes an inner surface (e.g., back surface) 24 and an outer surface (e.g., front surface) 25 which, according to one example, include a plurality of pin holes 30 distributed across the outer surface 25. The sleeve 20 also includes a first end 26 and a second end 27. The sleeve 20 is manufactured as a thin sheet and the first end 26 and the second end 27 are securably attached to each other (e.g., joined together) by any suitable means. For example, the first end 26 and the second end 27 are securably attached to each other by applying low heat and thereby melting a portion of the first end 26 and a portion of the second end 27 together. Accordingly, a firm seal that is difficult to break can be obtained. Accordingly, the sleeve 20 has approximately a conical shape and has a circular cross-sectional area. The sleeve 20 is configured to be shipped either as a flat sheet or as a sleeve.

The sleeve 20 is of any suitable size. According to one aspect, the first end 26 and the second end 27 have a same width which is the same width as a middle portion of the sleeve 20. As a specific example, the first end 26 and the second end 27 are about 3 inches in width. According to one aspect, the top side 21 of the sleeve 20 is about 10 inches in length. According to one aspect, the bottom side 22 of the sleeve 20 is about 8.5 inches in length. According to one aspect, the width of the sleeve 20 is about 0.125 inches.

As shown in FIG. 3, the sleeve 20 is made of a single layer of foam. However, the sleeve 20 is not limited to this particular implementation. For example, the sleeve 20 may be made of multiple layers of foam.

The sleeve 20 is configured to provide insulation and thereby reduce and/or prevent a risk of burning the hand 60 of the user when the user is holding the beverage container 10 holding a hot beverage. Accordingly, the sleeve 20 is made of a foam material. Although any suitable foam material may be used for the sleeve 20, the sleeve 20 may be made of polyethylene, for example low density polyethylene (LDPE). As an additional example, the sleeve 20 may be made of polyurethane which is an “open cell” foam which offers excellent resilience and durability and is available in a wide variety of densities and colors. Additionally, polyurethane exhibits good cushioning, and moisture absorption properties.

Accordingly, the sleeve 20 has good insulation properties due to the relatively low heat conductivity of the foam. The unique pin hole properties of the foam (due to the presence of the plurality of pin holes 30 in the sleeve 20) reduce a rate of heat transfer through the foam. Additionally, the sleeve 20 is lightweight because of the low weight of the foam, thereby reducing freight and shipping costs of the sleeve 20.

As one example, the foam has insulation properties which allow the sleeve 20 to reduce and/or prevent a rate of heat transfer between the inner surface 24 and the outer surface 25. More specifically, when a hot liquid having a temperature within a range of 200 and 212 degrees Fahrenheit (for example, 205 degrees Fahrenheit) is placed in the beverage container 10, the sleeve 20 on the outer surface 13 reduces a rate of heat transfer from the inner surface 24 to the outer surface 25. For example, the sleeve 20 is configured to reduce the rate of heat transfer from the inner surface 24 to the outer surface 25 such that the temperature at the outer surface 25 of the sleeve 20 is just above the body temperature of the user. As a specific example, the sleeve 20 is configured to reduce the rate of heat transfer such that the temperature at the outer surface 25 of the sleeve 20 is not greater than about 100 degrees Fahrenheit. As another specific example, the sleeve 20 is configured to reduce the rate of heat transfer such that the temperature at the outer surface 25 of the sleeve 20 is about 99 degrees Fahrenheit. Accordingly, unlike conventional cup holders made of corrugated paper, the sleeve 20 does not absorb heat but rather reduces or prevents heat conduction through the sleeve 20.

Another desirable property of the sleeve 20 is its durability due to the foam which can survive repeated washing (for example, washing by hand, etc.). The durability allows the sleeve to be used multiple times rather than only a single time like the prior art corrugated paper cup holders. Additionally, a used sleeve 20 can be stored in a pocket or purse of a user after use. Alternatively, a used sleeve 20 can be rolled up or squeezed into different orientations and will return to its usable orientation shown in FIG. 2 due to the mechanical elasticity of the foam material.

Yet another desirable property of the sleeve 20 is that it does not require glue to stay in place on the beverage container 10. Because of the friction between the outer surface 13 of the beverage container 10 and the foam of the sleeve 20, the sleeve 20 will remain in position on the beverage container 10 without requiring adjustment by a user.

Yet another desirable property of the foam of the sleeve 20 is that it can be recycled after use without causing increased greenhouse gas emissions during the recycling process. When the foam is recycled, it is useable as a material for a carpet pad, rebond material, or the foam may be shredded and used as stuffing filler for a variety of applications.

What is claimed is:

1. An insulating holder for a beverage container, comprising:
a sleeve comprising foam and further comprising a front surface and a back surface, the foam being configured to reduce a rate of heat transfer between the front surface and the back surface of the sleeve,
wherein the sleeve is configured to be placed around an outer surface of the beverage container, and
wherein the front surface of the sleeve is configured to be held in a hand of a user.

2. The insulating holder for a beverage container according to claim 1, wherein the foam comprises polyurethane.

3. The insulating holder for a beverage container according to claim 2, wherein the polyurethane is low density polyethylene.

4. The insulating holder for a beverage container according to claim 1, wherein the reduction in the rate of heat transfer between the front surface and the back surface of the sleeve is such that a temperature on the front surface of the sleeve is not greater than about 100 degrees Fahrenheit when a beverage held in the beverage container has a temperature of between 205 and 212 degrees Fahrenheit.

5. The insulating holder for a beverage container according to claim 4, wherein the reduction in the rate of heat transfer between the front surface and the back surface of the sleeve is such that the temperature on the front surface of the sleeve is about 99 degrees Fahrenheit when a beverage held in the beverage container has a temperature of between 205 and 212 degrees Fahrenheit.

6. The insulating holder for a beverage container according to claim 1, wherein the sleeve further comprises a first end and a second end.

7. The insulating holder for a beverage container according to claim 6, wherein the first end and the second end of the sleeve are melted together thereby providing a seal between the first end and the second end.

8. The insulating holder for a beverage container according to claim 1, wherein the sleeve has a conical shape having a circular cross section.

9. The insulating holder for a beverage container according to claim 1, wherein the sleeve is further configured to be reusable.

10. A beverage container and holder combination comprising:
a beverage container; and
an insulating holder comprising a sleeve comprising foam and further comprising a front surface and a back surface, the foam being configured to reduce a rate of heat transfer between the front surface and the back surface of the sleeve,
wherein the sleeve is configured to be placed around an outer surface of the beverage container, and
wherein the front surface of the sleeve is configured to be held in a hand of a user.

11. The combination according to claim 10, wherein the foam comprises polyurethane.

12. The combination according to claim 11, wherein the polyurethane is low density polyethylene.

13. The combination according to claim 10, wherein the reduction in the rate of heat transfer between the front surface and the back surface of the sleeve is such that a temperature on the front surface of the sleeve is not greater than about 100 degrees Fahrenheit when a beverage held in the beverage container has a temperature of between 205 and 212 degrees Fahrenheit.

14. The combination according to claim 13, wherein the reduction in the rate of heat transfer between the front surface and the back surface of the sleeve is such that the temperature on the front surface of the sleeve is about 99 degrees Fahrenheit when a beverage held in the beverage container has a temperature of between 205 and 212 degrees Fahrenheit.

15. The combination according to claim 10, wherein the sleeve further comprises a first end and a second end.

16. The combination according to claim 15, wherein the first end and the second end of the sleeve are melted together thereby providing a seal between the first end and the second end.

17. The combination according to claim 10, wherein the sleeve has a conical shape having a circular cross section.

18. The combination according to claim 10, wherein the sleeve is further configured to be reusable.

19. A method of insulating a beverage container, the method comprising:
providing a beverage container;
providing an insulating holder for the beverage container, the insulating holder comprising:
a sleeve comprising foam and further comprising a front surface and a back surface, the foam being configured to reduce a rate of heat transfer between the front surface and the back surface of the sleeve; and
inserting the beverage container into the sleeve,
wherein the sleeve is configured to be placed around an outer surface of the beverage container, and
wherein the front surface of the sleeve is configured to be held in a hand of a user.

20. The method according to claim 19, wherein the foam comprises low density polyurethane.
